(19) United States
(12) Patent Application Publication
(10) Pub. No.: US 2002/0077902 A1
(43) Pub. Date: Jun. 20, 2002

(54) Method and apparatus for verifying review and comprehension of information

(76) Inventor: Dwight Marcus, Ojai, CA (US)

Correspondence Address: J.D. Harriman II, COUDERT BROTHERS, 23rd Floor, 333 South Hope Street, Los Angeles, CA, 90071, US

(21) Appl. No.: 09/896,838

(22) Filed: Jun. 29, 2001

Related U.S. Application Data
(60) Provisional application No. 60/215,444, filed on Jun. 30, 2000.

(51) Int. Cl. G06F 17/60

(52) U.S. Cl. 705/14

(57) ABSTRACT

Embodiments of the present invention are directed to a method and apparatus for verifying review and comprehension of information. In one embodiment of the present invention, a verification system is used to verify that an information consumer attentively reviews provided information. In one embodiment, an incentive to review and comprehend information is provided for an information consumer. However, the review must be verified for the incentive to be given. In one embodiment, review verification is accomplished by introducing a series of signifiers into the provided information. In one embodiment, the information consumer is provided with instructions for indicating, directly or indirectly, the consumer's knowledge of the signifiers. In one embodiment, the user must indicate knowledge of a certain number of indicators to receive the incentive.

Applicant hereby claims priority to provisional patent application 60/215,444 filed Jun. 30, 2000.

### BACKGROUND OF THE INVENTION

1. Field of the Invention

The present invention relates to the field of information delivery verification, and in particular to a method and apparatus for verifying review and comprehension of information.

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

2. Background Art

Frequently, an information provider desires to verify that an information consumer reviewed some piece of information. For example, an advertiser desires to verify that an individual reviews an ad. For another example, an instructor desires to verify that a student reviews an assigned text. Prior art verification methods are inefficient and, sometimes, ineffectual. This problem can be better understood by a review of information review verification.

Information Review Verification

Frequently, an information provider desires to verify that the information consumer actually reviews the provided information. The information may be a picture, graphic, text, video, audio, computer code or any combination of these. For example, an advertiser is keenly interested in verifying that an ad was attentively reviewed by a consumer. In another example, an instructor desires to verify that a student has attentively reviewed an assigned text. The information provided can be in any format used to convey information.

Manufactures and service providers typically desire to verify that consumers review operational or safety information. For example, medical professionals desire to verify that health care recipients attentively review medication instructions and wellness information. In another example, computer software companies desire to verify that users read the manuals and other help information supplied with computer software.

Querying Information Consumers

One prior art method of verifying that an information consumer reviewed information is to ask the information consumer whether he or she reviewed the information. However, in many instances, verification is a higher priority concern for the information provider than it is for the information consumer. As a result, the information consumer may not respond or may respond that the information was reviewed when, in actuality, it was not.

The problem of false verification with this method increases if an incentive is provided for reviewing the information. For example, a business wishes to determine which advertising campaign is most effective, so the business offers a discount to customers who claim to have seen their ad. Since this is a common strategy used by businesses, a customer who has not seen the ad may guess that there is a discount for having seen the add. Thus, when asked whether the customer has seen the ad, the customer will falsely reply that he or she has.

The problem of false verification is also compounded if a real or perceived disincentive is provided for not reviewing the information. For example, students often falsely claim to have reviewed assigned texts when asked by instructors, since the students typically fear revealing that they have not read the assigned texts will result in a lower grade. In another example, a patient may falsely respond to a physician that the patient has reviewed provided medical or wellness information to avoid scorn or a lecture. In yet another example, a user of a product calling a help line may falsely claim to have read the instruction manual to avoid scorn from the help provider.

Another problem with the above method is that the information provider may not have the opportunity or resources to ask the information consumer whether the consumer reviewed the information. For example, an advertiser may not have the resources to ask every consumer exposed to an ad whether he or she reviewed the ad. The advertiser may not know who purchased a paper or magazine the ad was in or who had the radio or TV on when the ad was running.

Comprehension of Information

An information provider may require that the information be reviewed to with a certain amount of attention for the information to be considered comprehended. For example, an advertiser desires to verify that a consumer reviewed an ad attentively enough to know the advertiser's product, location, and/or other detailed information. In another example, in instructor desires to verify that a student reviewed an assigned text attentively enough to learn certain facts, concepts, and/or other detailed information.

One method for determining how attentively an information consumer reviews provided information is to test the consumer's knowledge of the information. For example, an instructor issues a test with questions covering details found in the assigned text. However, this method is not well suited for information providers who may not have the resources to test all information consumers. For example, some advertisers lack the resources to test everyone exposed to an ad.

The method is also problematic when the information consumer is not motivated to be tested on the information. For example, a test over an instruction manual provided with a product is unlikely to be completed and returned by the consumer. A further problem is that the testing may use an unacceptably large amount of time. For example, an instructor has a limited amount of class time to provide information to students. If the students are assigned a large number of texts, the instructor will not have sufficient class time to test whether each assigned text was reviewed sufficiently attentively by each student.

Additionally, in some instructional settings, assigned texts may be subject to interpretation. The instructor may believe that a student's learning process would be harmed by reading a text and preparing to answer questions covering detailed information found in the text. Instead, the instructor may believe a student should read the text and determine his or her own interpretation of the text. Thus, testing a student's knowledge of details of the text is counter to the instructor's beliefs.

In the circumstances above, the instructor may use a similar prior art method of verifying the information consumer reviewed the information. The instructor may look for evidence of detailed knowledge of the text in other work required of the student. For example, the instructor may look to see whether a student cites certain parts of the text when explaining his or her interpretation. However, this method is flawed because the student is able to spoof having detailed knowledge. The student may give the appearance of having attentively reviewed the entire text by learning a few details about the text and incorporating those details into any explanation required.

### SUMMARY OF THE INVENTION

Embodiments of the present invention are directed to a method and apparatus for verifying review and comprehension of information. In one embodiment of the present invention, a verification system is used to verify that an information consumer attentively reviews provided information. In one embodiment, an incentive to review and comprehend information is provided for an information consumer. The incentive can be any of a number of things desired by the information consumer. For example, the incentive could be reduced cost of a product or service. However, the review must be verified for the incentive to be given.

In one embodiment, review verification is accomplished by introducing a series of signifiers into the provided information. A signifier may be anything perceivable by an information consumer. For example, signifiers may be visual cues, such as words, letters, numbers, shapes, drawings or photographs. Signifiers may be a recognizable process or alteration to a sound or image, such as tints, blurs, echoes, flanging, and chorusing. For example, a user may be instructed before reviewing the information to record the order of the color of particular shapes. Signifiers may also be audibly perceivably items, such as words, tones, or other sounds.

In one embodiment, the information consumer is provided with instructions for indicating, directly or indirectly, the consumer's knowledge of the signifiers. For example, the information may contain the following sentence:

This sentence contains the signifier word ‘angry’, please copy down the letter at the end of this word.

This kind of signifier (in this case ‘y’) would be very hard to detect without careful review of the information provided. In another embodiment, the user gives an indication of knowledge of the signifiers, and a determination is made from the indication whether the consumer is granted the incentive.

In one embodiment, the user must indicate knowledge of a certain number of indicators to receive the incentive. In another embodiment, a formula is applied to the indications of the information consumer to determine whether the consumer receives the incentive. In one embodiment, different levels of incentives are provided to the information consumer dependent upon the indications provided by the consumer.

In one embodiment, a computer system is provided for recording a sequence of signifiers that has been caused to be included within provided information, for receiving an indication of knowledge of the signifiers, for comparing the indication with a predetermined indication level, and for providing an output indicating whether or not the received indication demonstrates an entitlement to something of value. The output may be furnished as an audible or visible indication to the information consumer, as well as being stored in a memory location in a suitably designed database.

In one embodiment, a code may be provided (on a card, on software, or otherwise) which converts signifiers to other types of information. In one embodiment, a peel-off or scratch off is used. For example, in one embodiment, a sequence of colors is included within a video program and marked on a card. In one embodiment, the card includes a key for converting the colors to numbers in some manner. In one embodiment, the numbers provide a telephone number for the user to call to claim the incentive reward. In another embodiment, the signifiers are the item of value, or incentive. In one embodiment, the signifiers provide a desired item of information.

In different embodiments of the invention, indicators may be made by any method by which the user communicates comprehension of the information. In one embodiment, an indication is made by placing a telephone call. In another embodiment, an indication is made by connection to a website. In yet another embodiment, an indication is made by electronic mail. In still another embodiment, an indication is made by postal mailing, faxing or otherwise transmitting a written response. Other embodiments use other methods of indicating comprehension of the information.

In one embodiment, signifiers are distributed throughout multiple sets of information. The sets of information may be of different types. For example, the signifiers necessary for sufficient indication of comprehension are divided among a radio ad, a television ad, a newspaper ad and an internet web site.

In one embodiment, a no-cost or low-cost incentive item is furnished to the information consumer in a locked manner, such as a password protected, in electronic format on a storage medium. The item may be an audio or visual program, such as a motion picture, or a computer program. The storage medium may be a DVD or CD-ROM. In another embodiment, the information consumer accesses an item without a storage medium, (e.g., through remote access via interactive television, a computer network or the Internet).

The password or other required key to access of the item is only obtained by reviewing a training or advertising program provided to the information consumer. The information consumer must attentively review the entire program before the incentive item is ‘unlocked’ because of the embedded sequence of signifiers.

In one embodiment, the information is in print media form. The signifiers are placed in a normally typeset sentence. Since the signifiers' locations are not know to the information consumer and since the signifiers are typeset like the rest of the information, it is difficult to locate the signifiers without careful review of the information.

In one embodiment, the information is instructional material relating to a product or service. The incentive for reviewing the information is enhanced or lower cost product and technical support for the product or service.

In one embodiment, the signifiers are required to obtain a potentially winning number in a contest or lottery. In one embodiment, the key, used to translate from signifiers to lottery number, is provided in the form of a game card. In one embodiment, the number is directly revealed by the signifiers. In another embodiment, signifiers inform a consumer of the scratch-off, peel-off, or add-on pattern to be performed to reveal the number.

In one embodiment, an advertiser distributes a card and places a signifier or several signifiers in each of several ads. The information consumer must “mindfully consume” each ad. In one embodiment, the signifiers are placed across a related “package” of ads or other programming by a vendor. In one embodiment, a network places the signifiers across a widely-watched sporting event, and an answer card is placed in the Sunday paper. Thus, the likelihood increases of more consumers attentively reviewing the ads rather than taking bathroom breaks during the event.

Since the network could confirm the amount of viewers who reviewed each ad, the network could either adjust advertising rates for the future or base a portion of the rates on the number of confirmed viewers. In one embodiment, related products like makeup, hair products and fashion items or jogging shoes, sportswear and sporting goods are teamed to complete a signifier-sequence.

In another embodiment, the key to translating signifiers into useful contact information may be obtained only by performing one or more specific actions (e.g., purchasing a product). In one embodiment, that game card having the key is provided after visiting a store or other location in person. In another embodiment, a game card is available only after attending an in-person presentation on a product.

In yet another embodiment, the information consumer is asked to record, by any means, the nature of and the order of the signifiers and call or e-mail the information to a location. The information is applied to a randomly or strategically-generated electronic lottery-card.

In one embodiment, additional information is presented to the information consumer upon receiving contact from the consumer. In one embodiment, a consumer who telephones a number hears a telephone message with suitable advertising before learning whether the number presented is or is not a winning number. Thus, the information consumer reviews the additional advertising information. Other embodiments present advertising through other media. In one embodiment, a website is programmed to generate advertising text or images before providing an indication of whether a number is a winner or not.

In another embodiment, signifiers in a program generate contact information (e.g., a telephone number). In one embodiment, the contact information is a toll-free telephone number. The message received after using the contact information furnishes added value to the consumer. In one embodiment, signifiers in an ad provide contact information in the form of a telephone number. A recorded audio advertisement delivered to the caller includes as signifiers further contact information, or some or all elements of an access code.

A third advertisement, delivered as the result of using the contact information furnished by the second advertisement, provides further information, seen as further contact information or the final digits of a code number. By accessing successive ads, the information consumer indicates his or her attentive review of the previous ad. As a result, the system generates a reward of prizes or coupons for the consumer.

In one embodiment, an advertiser purchases real or virtual visually-perceivable advertising space. The advertisements appear, continuously or periodically, during all or a portion of the duration of the event. In one embodiment, the event is a sporting game or exhibition. In another embodiment, the event is a concert or other performance. In one embodiment, the space is the ballpark fence during a televised game.

In one embodiment, signifiers appearing on a particular location change during the duration of the event. In another embodiment, different signifiers appear at different locations that are seen during the event. In one embodiment, video imaging techniques are used to display ads on the ballpark fence. In another embodiment, video imaging techniques are used to display ads on the ballpark field. In one embodiment the virtual ads are animated. In one embodiment, the location of the virtual ads is a signifier. In another embodiment, content within the virtual ad is a signifier.

In one embodiment, instructions are provided to viewers to record the signifiers on paper or on a game card or coupon provided during some other interaction. After collecting the entire series of signifiers furnished during the vent, a variety of valuable outcomes are offered to the consumer. In one embodiment, the number of correct signifiers shifts the value of the coupon.

In another embodiment, a non-unitary product (e.g., a pack of beverage containers or a set of tools) holds a series of signifiers distributed across the individual parts. In yet another embodiment, each product in the series contains instructions that cause modification to the remaining signifiers. For example, one item in the group provides instructions as to which signifiers, or signifier positioning, coloring, or other characteristic to value in the creation of the final signifier string. The remaining products provide signifiers themselves.

In one embodiment, a limited signifier set is defined to prevent replies from users of undesirable mixed product sets. For example, a user might purchase individual items separately. This type of tactic is detected when the invalid signifier strings are received.

In another embodiment, the presence of a win/lose status or other unique status is detected by the application of the set-limiting concept of error detection scheme without knowing the precise contents of a winning, or statistically significant, signifier string. In one embodiment, rarely occurring, or other “marked”, signifiers are present only in a specific portion of the string. In another embodiment, information such as the geographical location of the origin of a ‘winning’ series are coded to “ride” on the winning set using the concept of “allowed” sets of signifiers in any or all positions of the final string.

In one embodiment, an article for recording signifiers has a substrate having thereon multiple layers. The layers contain information. In one embodiment, the information is perceivable to humans. In another embodiment, the information is printed information. Each layer is divided into multiple portions. By revealing the proper portions in each layer, specific information, such as an indication or a winning number, a unitary image, or other information is revealed.

In one embodiment, the substrate is a generally planar substrate, such as a card or other suitable paper product. In one embodiment, the card is a single sheet of paper or other suitable material, or its cybernetic counterpart. Cybernetic includes computing devices of any technology, including electronic and optical. In one embodiment, overprinting is applied on a scratch-off, tear-off, peel-off or other form of layered-reveal card. The overprinting or portion thereof is combined with the underprinting revealed by the selective removal of the scratch-off or peel-off layer to form a composite signifier or signifier strings by the unexpected juxtaposition of the two layers of printed information.

In another embodiment, a substrate is wholly or partly formed of a transparent or translucent medium. In one embodiment, the medium is covered with an opaque or translucent medium such as peel-off or scratch-off regions. In one embodiment, the regions are rectangular X by Y grid configurations. In other embodiments, other suitable configurations are used. The regions are printed or otherwise imbued on their exposed surface(s) with an image comprised of desired information, signifiers, images, or portions thereof.

In one embodiment, the printed image is divided into a grid of 4×4 elements. Grid regions of the translucent/transparent (image-bearing) material are left unprinted or are printed or otherwise coated with signifiers. The rear surface of the translucent panel/card is likewise coated with peel-off or scratch-off regions with the following modification: Before coating or otherwise covering the rear surface, the clear card is also printed or otherwise imbued with signifiers, images, or portions thereof.

In one embodiment, selected areas of the transparent/translucent card are coated with obscuring regions of material of the same color or appearance (including random-like fields of confusing colors, shapes, or the like). In one embodiment, the fields are applied to the rear surface of the peel-off or scratch-off material affixed to the rear surface of the translucent layer.

In one embodiment, a desired result (e.g., a winning number or image, a desired phone-number, date, prize, or other required information) is divided across the multiple planes of a card. This division is likely done in X by Y regions which correspond to the regions defined by the layered reveal regions of the card. In one embodiment, the complexity of the encrypting of this data is further complicated through the use of operations by the information consumer that require the repositioning of the removable regions of either of the card's surfaces. This operation might include the removal of front or rear sections and their replacement onto the same, or opposing card-surfaces through the use of reusable adhesive or other methods. In other embodiments, further complication is added by addition or subtraction by the user of obscuring layers.

The signifiers in the information enable the information consumer to engage in the removal, application, and/or repositioning of the X by Y elements on either or both sides of the card. When this process is completed, the desired information, image, number, or signifier is revealed.

In one embodiment, the card has multiple layers. In another embodiment, there are multiple (clear) cards that are obtained from multiple sources. Operation of each card depends upon the source, the date of review, or other operator. After performing a series of signifier driven operation on the cards, the cards are stacked upon one another. In another embodiment, a fan-fold configuration is created which reveals a winning image or sequence only after the folding-together of multiple layers of such a card.

In another embodiment, a card is also modified by placement of a cut-out mask over or under the cards described above in order to modify, attenuate, or complete the image or sign appearing on the surfaces of the card. In one embodiment, scratch-off, tear-off, or peel-off layers are translucent and in this way make use of novel superimposition effects. In one embodiment, characters that appear to be present when viewing through the entirely translucent, tinted or transparent stack are made to disappear when appropriate layers are removed under instruction. Transparent layers tinted with the same color as the signifying markings below the tinted layer make layers below disappear, and complementary colors create the inverse effect.

In different embodiments, the central or transparent/translucent and perhaps tinted layer of a card employs lenticular technology, (reflective) holography, or other dynamic-imaging or depth-imaging methodologies to embody a plurality of images, signifiers or their component parts, in order to create any of the sequential or three-dimensional effects possible with lenticular systems and the like. In another embodiment, a peel-off layer of transparent/translucent material with the complementary geometry to the lenticular screen and possessing the same or nearly the same index of refraction is placed against the lenticular prism or other optical layer, until the time of deployment. Thus, a motional, sequential, informational, or depth effect is created.

In another embodiment, cards sent though e-mail, US mail, or received through local papers or magazines allow the encoding of various, unique, or differentiated “winning” response strings to be derived from the same signifier strings that appear sequentially in provided information. In another embodiment, multiple or variant signifiers placed in the information, or varied streams of signifiers such as might be created by a varying sequence of ad-insertions in, say, different geographic or demographic regions or groups, are employed to vary the actual response across the response grid or a card.

In one embodiment, certain combinations are disallowed to detect frivolous, intentional, or accidental misuse of the response system. In another embodiment, the card employed to respond to the presented signifier string is encoded with local phone numbers or variant toll-free numbers or other similar strategies. The toll-free number dialed, combined (or not) with a actual response string yields radically different results, like rewards or information.

In one embodiment, response cards are manufactured as an integral part of a product. A see-through card is manufactured using the cover of a product as the medium. In another embodiment, the alignment of the DVD or CD disc is used to produce the second layer or x-layer of an assemblage such as is described above.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of information review verification in accordance with one embodiment of the present invention.

FIG. 2 is a flow diagram of the process of information review verification with multiple incentive levels in accordance with one embodiment of the present invention.

FIG. 3 is a flow diagram of the process of verifying information review using a signifier conversion code in accordance with one embodiment of the present invention.

FIG. 4 is a flow diagram of the process of verifying information review of information form multiple sources in accordance with one embodiment of the present invention.

FIG. 5 is a flow diagram of the process of verifying information review of information to obtain access to a product in accordance with one embodiment of the present invention.

FIG. 6 is a flow diagram of the process of verifying review of information using a lottery as incentive in accordance with one embodiment of the present invention.

FIG. 7 is a flow diagram of the process of verifying review of information using a lottery as incentive without an information consumer possessed game card in accordance with one embodiment of the present invention.

FIG. 8 is a flow diagram of the process of verifying a series of information reviews in accordance with one embodiment of the present invention.

FIG. 9 is a flow diagram of the process of review verification of information placed at an event.

FIG. 10 is a block diagram of a system for displaying virtual information in accordance with one embodiment of the present invention.

FIG. 11 is a flow diagram of the process of composing a signifier string in accordance with one embodiment of the present invention.

FIG. 12 is a block diagram of portions of a recording card in accordance with one embodiment of the present invention.

FIG. 13 is a block diagram of a distribution of meaningful material over the multitude of surfaces of a recording card.

FIG. 14 is a flow diagram of the process of review verification in accordance with one embodiment of the present invention.

FIG. 15 is a flow diagram of the process of verifying student review of assigned text in accordance with one embodiment of the present invention.

FIG. 16 is a block diagram of a general purpose computer.

### DETAILED DESCRIPTION OF THE INVENTION

The invention is a method and apparatus for verifying review and comprehension of information. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Incentive-Based Verification System

In one embodiment of the present invention, a verification system is used to verify that an information consumer attentively reviews provided information. In one embodiment, an incentive to review and comprehend information is provided for an information consumer. The incentive can be any of a number of things desired by the information consumer. For example, the incentive could be reduced cost of a product or service. However, the review must be verified for the incentive to be given.

Signifiers

In one embodiment, review verification is accomplished by introducing a series of signifiers into the provided information. A signifier may be anything perceivable by an information consumer. For example, signifiers may be visual cues, such as words, letters, numbers, shapes, drawings or photographs. Signifiers may be a recognizable process or alteration to a sound or image, such as tints, blurs, echoes, flanging, and chorusing. For example, a user may be instructed before reviewing the information to record the order of the color of particular shapes. Signifiers may also be audibly perceivably items, such as words, tones, or other sounds.

In one embodiment, the information is in print media form. The signifiers are placed in a normally typeset sentence. Since the signifiers' locations are not know to the information consumer and since the signifiers are typeset like the rest of the information, it is difficult to locate the signifiers without careful review of the information.

In one embodiment, the information consumer is provided with instructions for indicating, directly or indirectly, the consumer's knowledge of the signifiers. For example, the information may contain the following sentence:

This sentence contains the signifier word ‘angry’, please copy down the letter at the end of this word.

This kind of signifier (in this case ‘y’) would be very hard to detect without careful review of the information provided. In another embodiment, the user gives an indication of knowledge of the signifiers, and a determination is made from the indication whether the consumer is granted the incentive.

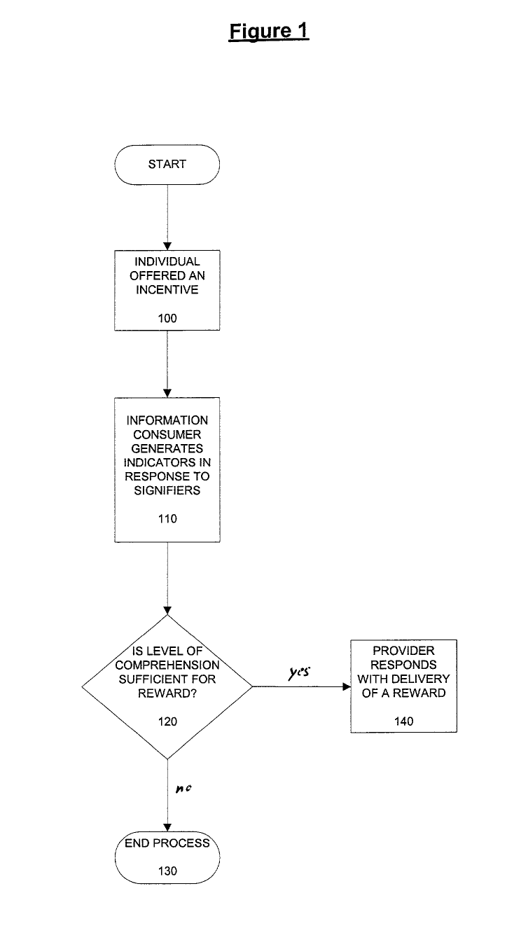

In one embodiment, the user must indicate knowledge of a certain number of indicators to receive the incentive. FIG. 1 illustrates the process of information review verification in accordance with one embodiment of the present invention. At step 100, an individual is offered an incentive (personal, monetary, desired, required or requested information etc.) for generating a response to a presented series of stimuli.

At step 110, the information consumer generates indicators in response to signifiers in the information. At step 120, it is determined whether the level of comprehension is sufficient for reward. If the level of comprehension is not sufficient for reward, the process ends at step 130. If the level of comprehension is sufficient for reward, at step 140, the provider responds with the delivery of a reward for the mindful watching of the programming.

In different embodiments of the invention, indicators may be made by any method by which the user communicates comprehension of the information. In one embodiment, an indication is made by placing a telephone call. In another embodiment, an indication is made by connection to a website. In yet another embodiment, an indication is made by electronic mail. In still another embodiment, an indication is made by postal mailing, faxing or otherwise transmitting a written response. Other embodiments use other methods of indicating comprehension of the information.

In another embodiment, a formula is applied to the indications of the information consumer to determine whether the consumer receives the incentive. In one embodiment, different levels of incentives are provided to the information consumer dependent upon the indications provided by the consumer.

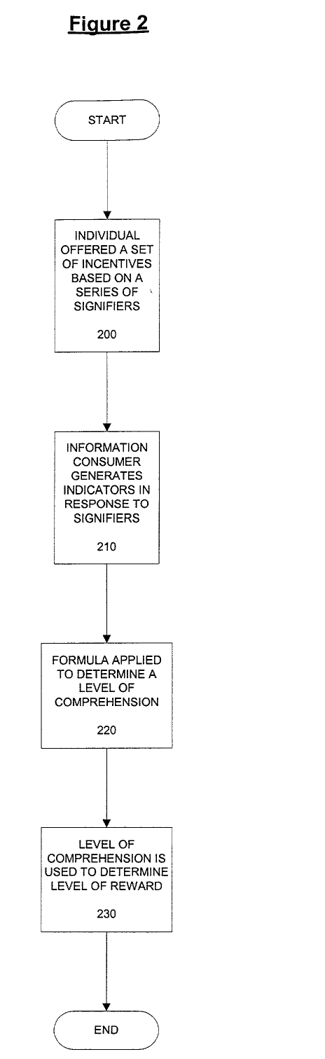

FIG. 2 illustrates the process of information review verification with multiple incentive levels in accordance with one embodiment of the present invention. At step 200, an individual is offered a set of incentives for generating indications in response to a series of signifiers presented throughout provided information. At step 210, the information consumer generates indications in response to signifiers. At step 220, a formula is applied to the indications to determine a level of comprehension. At step 230, the level of comprehension is used to determine the level of the reward granted to the information consumer.

Signifier Conversion Codes

In one embodiment, a code may be provided (on a card, on software, or otherwise) which converts signifiers to other types of information. In one embodiment, a peel-off or scratch off is used. For example, in one embodiment, a sequence of colors is included within a video program and marked on a card. In one embodiment, the card includes a key for converting the colors to numbers in some manner. In one embodiment, the numbers provide a telephone number for the user to call to claim the incentive reward. In another embodiment, the signifiers are the item of value, or incentive. In one embodiment, the signifiers provide a desired item of information.

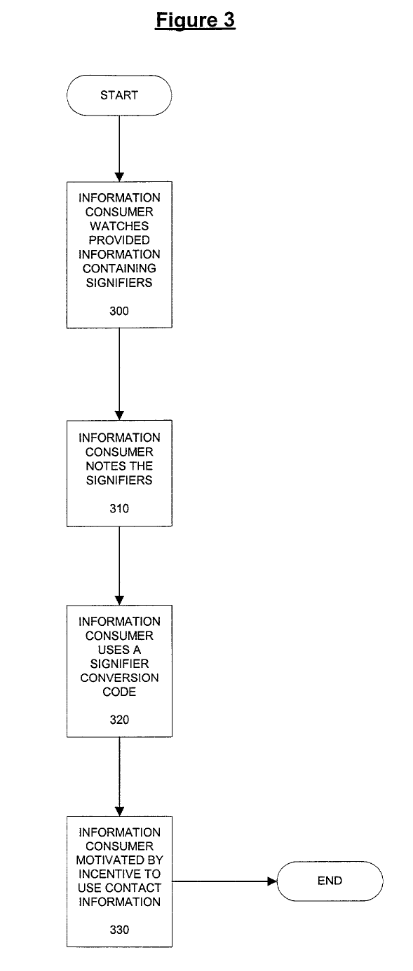

FIG. 3 illustrates the process of verifying information review using a signifier conversion code in accordance with one embodiment of the present invention. At step 300, the information consumer watches provided information containing signifiers. At step 310, the information consumer notes the signifiers. At step 320, the information consumer uses a signifier conversion code to reveal a contact information. At step 330, the information consumer is motivated by an incentive to use the contact information. By using the contact information, the information consumer verifies that he or she has reviewed the information with the desired level of comprehension.

Signifier Series Through Multiple Information Sources

In one embodiment, signifiers are distributed throughout multiple sets of information. The sets of information may be of different types. For example, the signifiers necessary for sufficient indication of comprehension are divided among a radio ad, a television ad, a newspaper ad and an internet web site.

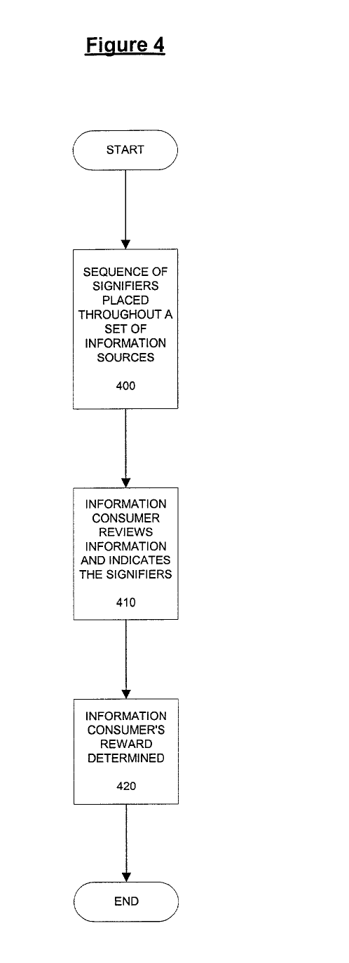

FIG. 4 illustrates the process of verifying information review of information form multiple sources in accordance with one embodiment of the present invention. At step 400, a sequence of signifiers is placed throughout a set of information sources. At step 410, an information consumer reviews the information sources and indicates the signifiers. At step 420, the information consumer's reward is determined from the indications.

Forcing Review of Information to Use Product

In one embodiment, a no-cost or low-cost incentive item is furnished to the information consumer in a locked manner, such as a password protected, in electronic format on a storage medium. The item may be an audio or visual program, such as a motion picture, or a computer program. The storage medium may be a DVD or CD-ROM. In another embodiment, the information consumer accesses an item without a storage medium, (e.g., through remote access via interactive television, a computer network or the Internet).

The password or other required key to access of the item is only obtained by reviewing a training or advertising program provided to the information consumer. The information consumer must attentively review the entire program before the incentive item is ‘unlocked’ because of the embedded sequence of signifiers.

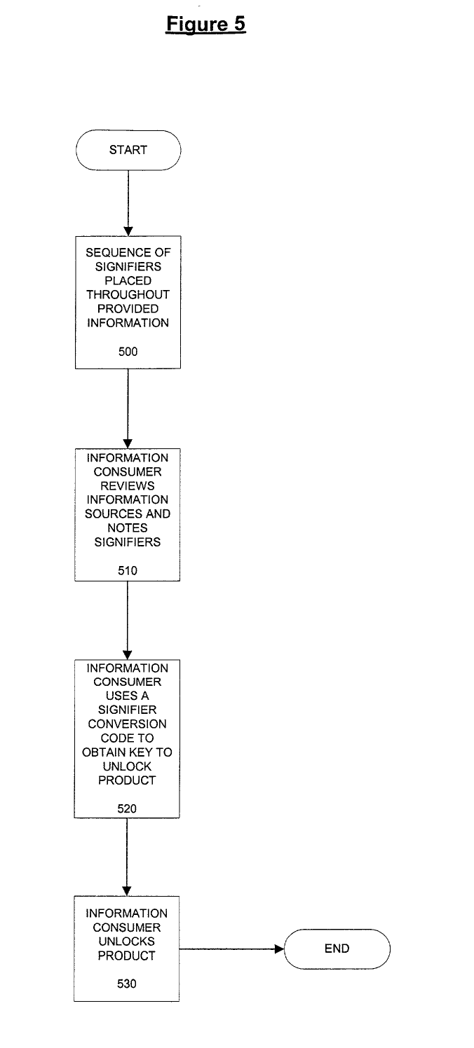

FIG. 5 illustrates the process of verifying information review of information to obtain access to a product in accordance with one embodiment of the present invention. At step 500, a sequence of signifiers is placed throughout provided information. At step 510, an information consumer reviews the information sources and notes the signifiers. At step 520, the information consumer uses a signifier conversion code to obtain a key to unlock the product. At step 530, the information consumer unlocks the product.

In one embodiment, the information verification system is used to prevent access to medication until medical instructions are sufficiently reviewed. The medication is provided in a locked container. The patient must review the medical instructions to locate signifiers that are used to produce the code that opens the lock. In this way, medical providers can ensure their patients are knowledgeable about their care regimen. This may help to improve patient health and lower medical provider liability.

In one embodiment, the information is instructional material relating to a product or service. The incentive for reviewing the information is enhanced or lower cost product and technical support for the product or service. Customer support lines generally do not generate revenue for a business. As a result, businesses desire to keep their customer support resources at minimal levels. However, businesses also receive pressure to supply customer support from consumers.

Some calls to customer service would be unnecessary if the user attentively read the user's manual that comes with the product. Thus, a business can reduce the number of calls to customer service by charging for calls to a published number and placing signifiers that reveal a reduced cost or toll-free customer support number throughout the instruction manual. By calling the toll-free number, the customer is automatically verifying that he or she has reviewed and comprehended the user's manual, but still needs assistance.

Game Cards

In one embodiment, the signifiers are required to obtain a potentially winning number in a contest or lottery. In one embodiment, the key, used to translate from signifiers to lottery number, is provided in the form of a game card. In one embodiment, the number is directly revealed by the signifiers. In another embodiment, signifiers inform a consumer of the scratch-off, peel-off, or add-on pattern to be performed to reveal the number.

In one embodiment, an advertiser distributes a card and places a signifier or several signifiers in each of several ads. The information consumer must “mindfully consume” each ad. In one embodiment, the signifiers are placed across a related “package” of ads or other programming by a vendor. In one embodiment, a network places the signifiers across a widely-watched sporting event, and an answer card is placed in the Sunday paper. Thus, the likelihood increases of more consumers attentively reviewing the ads rather than taking bathroom breaks during the event.

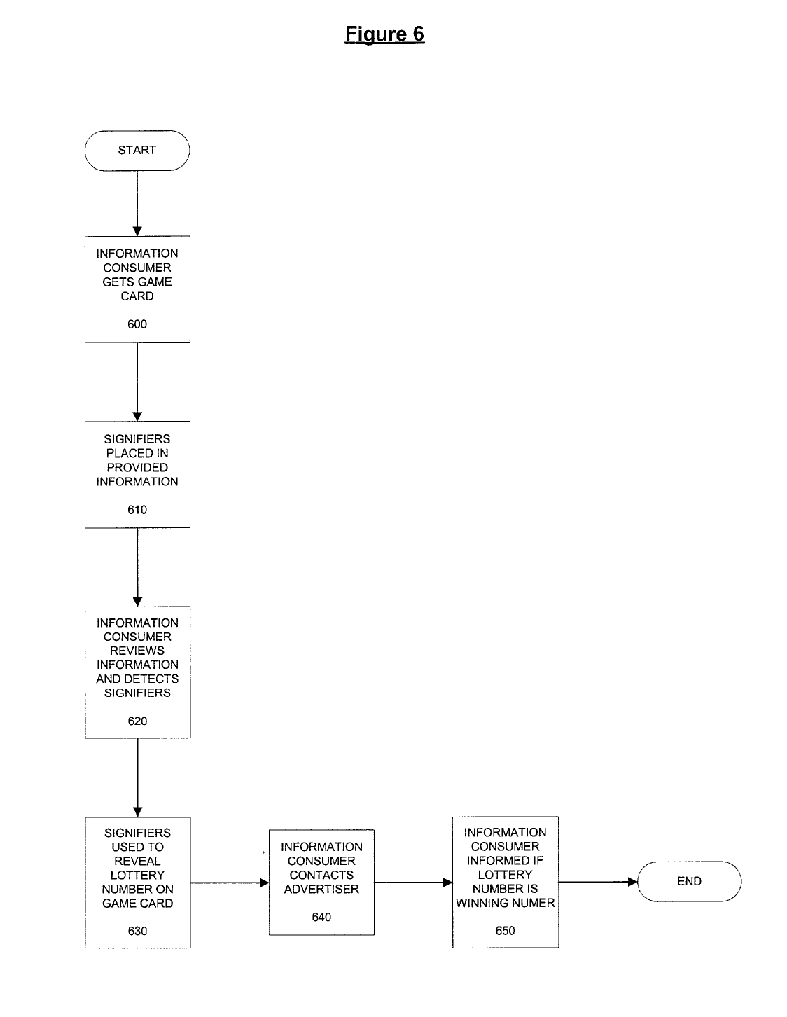

FIG. 6 illustrates the process of verifying review of information using a lottery as incentive in accordance with one embodiment of the present invention. At step 600, an information consumer obtains a game card. At step 610, signifiers are placed in provided information (e.g., an advertisement). At step 620, the information consumer reviews the information and detects the signifiers. At step 630, the signifiers are used to reveal a lottery number on the game card. At step 640, the information consumer contacts the advertiser to determine whether the lottery number is the winning number, thereby verifying that the information consumer has reviewed and comprehended the information. At step 650, the information consumer is informed of whether the lottery number was the winning number.

Since a network could confirm the amount of viewers who reviewed each ad, the network could either adjust advertising rates for the future or base a portion of the rates on the number of confirmed viewers. In one embodiment, related products like makeup, hair products and fashion items or jogging shoes, sportswear and sporting goods are teamed to complete a signifier-sequence.

In another embodiment, the key to translating signifiers into useful contact information may be obtained only by performing one or more specific actions (e.g., purchasing a product). In one embodiment, that game card having the key is provided after visiting a store or other location in person. In another embodiment, a game card is available only after attending an in-person presentation on a product.

In yet another embodiment, the information consumer is asked to record, by any means, the nature of and the order of the signifiers and call or e-mail the information to a location. The information is applied to a randomly or strategically-generated electronic lottery-card.

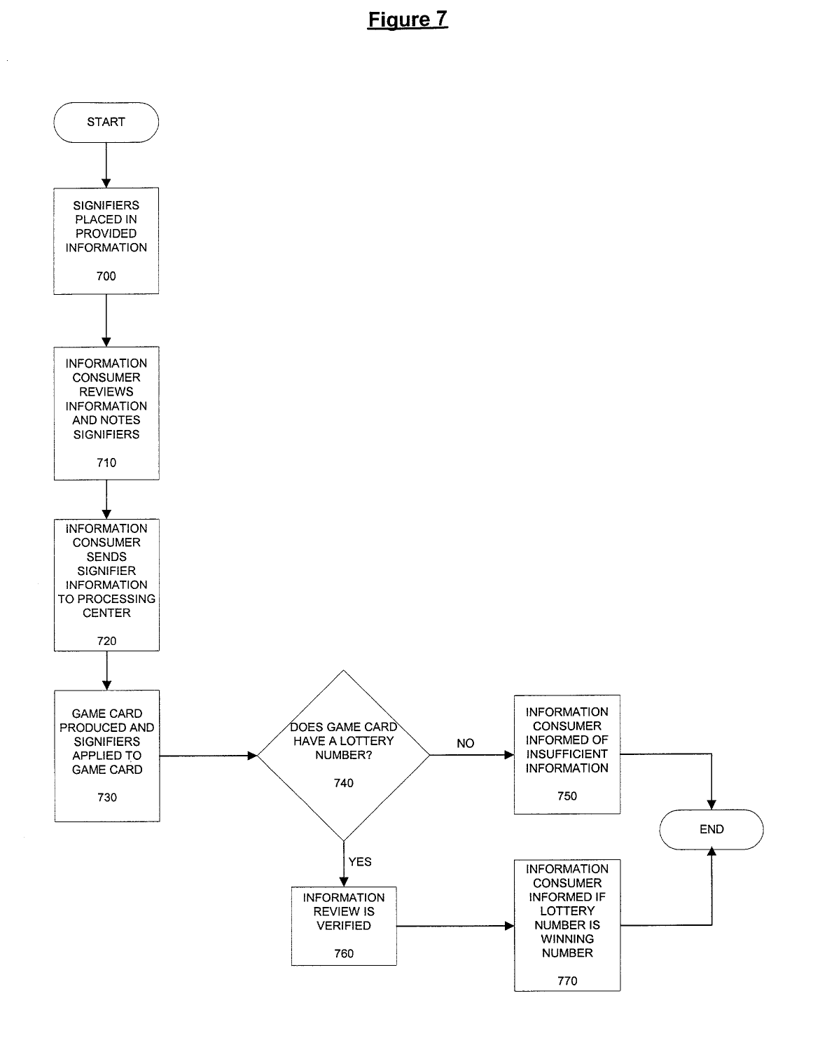

FIG. 7 illustrates the process of verifying review of information using a lottery as incentive without an information consumer possessed game card in accordance with one embodiment of the present invention. At step 700 signifiers are placed in provided information (e.g., an advertisement). At step 710, the information consumer reviews the information and notes the signifiers. At step 720, the information consumer sends the signifier information to a processing center. At step 730, a game card is produced at the processing center and the signifier information provided by the information consumer is applied to the game card.

At step 740, it is determined whether the signifier information applied to the game card reveals a lottery number. If the signifier information applied to the game card does not reveal a lottery number, at step 750, information review is not verified and the information consumer is instructed that the information was not sufficiently reviewed. If the signifier information applied to the game card reveals a lottery number, at step 760, information review is verified. At step 770, the information consumer is informed of whether the lottery number was the winning number.

In one embodiment, the information consumer sends the game card to the information provider. The operation of a fault-tolerant system for judging responses on the game card is described in co-pending U.S. Provisional Patent Application Ser. No. ______ , filed September, 2000, entitled “______” and incorporated herein by reference.

Additional Information or Signifiers Upon Review Verification

In one embodiment, additional information is presented to the information consumer upon receiving contact from the consumer. In one embodiment, a consumer who telephones a number hears a telephone message with suitable advertising before learning whether the number presented is or is not a winning number. Thus, the information consumer reviews the additional advertising information. Other embodiments present advertising through other media. In one embodiment, a website is programmed to generate advertising text or images before providing an indication of whether a number is a winner or not.

In another embodiment, signifiers in a program generate contact information (e.g., a telephone number). The contact information is a toll-free telephone number. The message received after using the contact information furnishes added value to the consumer. Signifiers in the ad provide contact information in the form of a telephone number. A recorded audio advertisement delivered to the caller includes as signifiers further contact information, or some or all elements of an access code.

A third advertisement, delivered as the result of using the contact information furnished by the second advertisement, provides further information, seen as further contact information or the final digits of a code number. By accessing successive ads, the information consumer indicates his or her attentive review of the previous ad. As a result, the system generates a reward of prizes or coupons for the consumer.

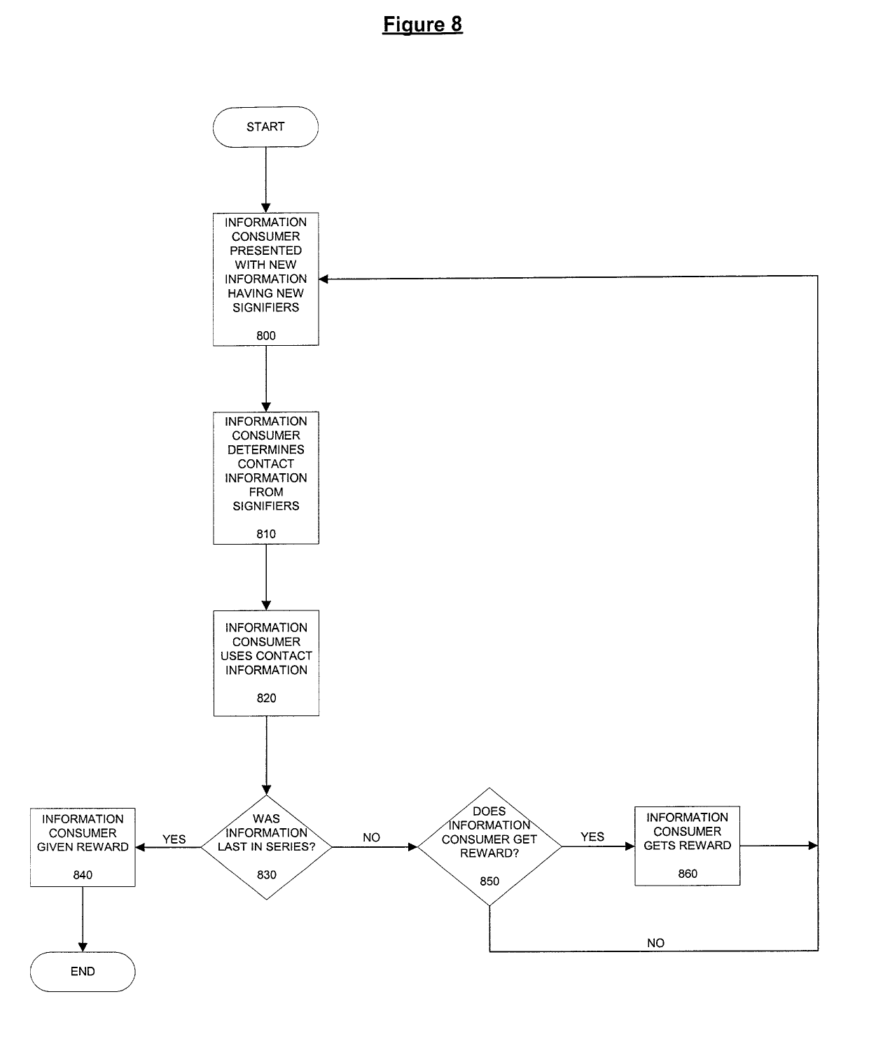

FIG. 8 illustrates the process of verifying a series of information reviews in accordance with one embodiment of the present invention. At step 800, an information consumer is presented with new information containing new signifiers. At step 810, the information consumer determines contact information from the signifiers. At step 820, the information consumer uses the contact information.

At step 830, it is determined whether the information was the last in the series of information. If the information was the last in the series of information, at step 840, the information consumer is given a reward. If the information was not the last in the series of information, at step 850, it is determined whether there is a reward for the information consumer making this contact. If there is a reward for the information consumer making this contact, at step 860, the information consumer is given a reward and the process continues at step 800. If there is not a reward for the information consumer making this contact, the process repeats at step 800.

Event Focused Information

In one embodiment, an advertiser purchases real or virtual visually-perceivable advertising space. The advertisements appear, continuously or periodically, during all or a portion of the duration of the event. In one embodiment, the event is a sporting game or exhibition. In another embodiment, the event is a concert or other performance. In one embodiment, the space is the ballpark fence during a televised game.

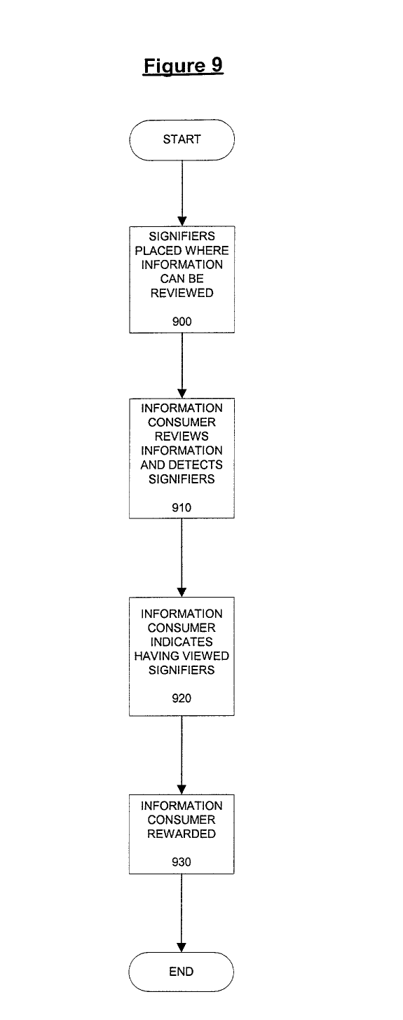

FIG. 9 illustrates the process of review verification of information placed at an event. At step 900, information containing signifiers is placed where the information will be reviewable at an event. At step 910, an information consumer reviews the information and detects the signifiers. At step 920, the information consumer indicates having viewed the signifiers, thus verifying the consumer reviewed and comprehended the information. At step 930, the information consumer is rewarded.

In one embodiment, signifiers appearing on a particular location change during the duration of the event. In another embodiment, different signifiers appear at different locations that are seen during the event. In one embodiment, video imaging techniques are used to display ads on the ballpark fence. In another embodiment, video imaging techniques are used to display ads on the ballpark field. In one embodiment the virtual ads are animated. In one embodiment, the location of the virtual ads is a signifier. In another embodiment, content within the virtual ad is a signifier.

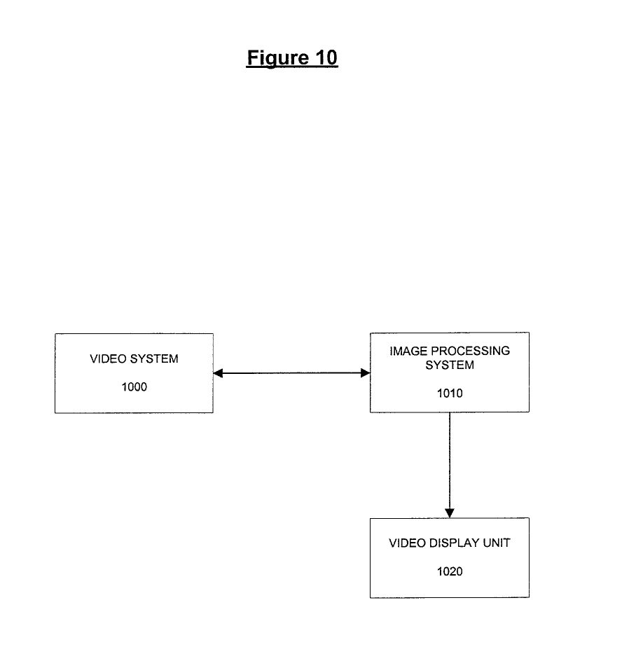

FIG. 10 illustrates a system for displaying virtual information in accordance with one embodiment of the present invention. Images of an event are converted into computer readable information by a video system 1000. The video system is coupled to an image processing system 1010 that analyzes the images and alters the image information to place information containing signifiers at appropriate locations in the images. The image processing system is coupled to a video display unit 1020 where the altered image containing the information with signifiers is displayed.

In one embodiment, instructions are provided to viewers to record the signifiers on paper or on a game card or coupon provided during some other interaction. After collecting the entire series of signifiers furnished during the vent, a variety of valuable outcomes are offered to the consumer. In one embodiment, the number of correct signifiers shifts the value of the coupon.

Non-Unitary Products

In another embodiment, a non-unitary product (e.g., a pack of beverage containers or a set of tools) holds a series of signifiers distributed across the individual parts. In yet another embodiment, each product in the series contains instructions that cause modification to the remaining signifiers. For example, one item in the group provides instructions as to which signifiers, or signifier positioning, coloring, or other characteristic to value in the creation of the final signifier string. The remaining products provide signifiers themselves.

In one embodiment, a limited signifier set is defined to prevent replies from users of undesirable mixed product sets. For example, a user might purchase individual items separately. This type of tactic is detected when the invalid signifier strings are received.

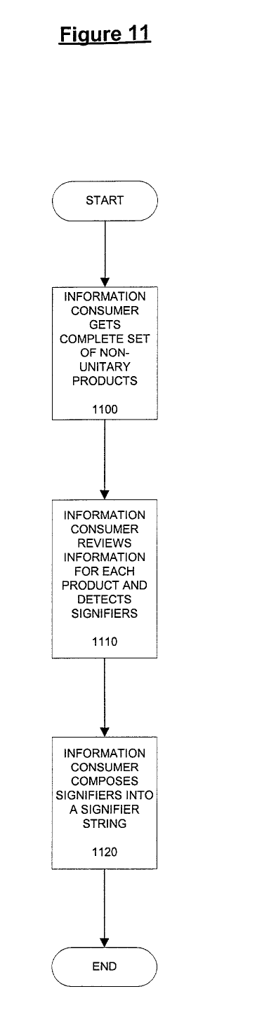

FIG. 11 illustrates the process of composing a signifier string in accordance with one embodiment of the present invention. At step 1100, the information consumer obtains a complete set of a non-unitary product. At step 1110, the information consumer reviews information for each element of the set and detects signifiers in the information. At step 1120, the information consumer composes the signifiers into a signifier string according to instructions of one of the signifiers.

In another embodiment, the presence of a win/lose status or other unique status is detected by the application of the set-limiting concept of error detection scheme without knowing the precise contents of a winning, or statistically significant, signifier string. In one embodiment, rarely occurring, or other “marked”, signifiers are present only in a specific portion of the string. In another embodiment, information such as the geographical location of the origin of a ‘winning’ series are coded to “ride” on the winning set using the concept of “allowed” sets of signifiers in any or all positions of the final string.

Recording Cards

The operation of recording cards is described in co-pending U.S. Provisional Patent Application Ser. No. 60/215,444, filed Jun. 30, 2000, entitled “Methods of Verifying and Rewarding Review of Information” and incorporated herein by reference.

In one embodiment, an article for recording signifiers has a substrate having thereon multiple layers. The layers contain information. In one embodiment, the information is perceivable to humans. In another embodiment, the information is printed information. Each layer is divided into multiple portions. By revealing the proper portions in each layer, specific information, such as an indication or a winning number, a unitary image, or other information is revealed.

In one embodiment, the substrate is a generally planar substrate, such as a card or other suitable paper product. In one embodiment, the card is a single sheet of paper or other suitable material, or its cybernetic counterpart. Cybernetic includes computing devices of any technology, including electronic and optical. In one embodiment, overprinting is applied on a scratch-off, tear-off, peel-off or other form of layered-reveal card. The overprinting or portion thereof is combined with the underprinting revealed by the selective removal of the scratch-off or peel-off layer to form a composite signifier or signifier strings by the unexpected juxtaposition of the two layers of printed information.

In another embodiment, a substrate is wholly or partly formed of a transparent or translucent medium. In one embodiment, the medium is covered with an opaque or translucent medium such as peel-off or scratch-off regions. In one embodiment, the regions are rectangular X by Y grid configurations. In other embodiments, other suitable configurations are used. The regions are printed or otherwise imbued on their exposed surface(s) with an image comprised of desired information, signifiers, images, or portions thereof.

In one embodiment, the printed image is divided into a grid of 4×4 elements. Grid regions of the translucent/transparent (image-bearing) material are left unprinted or are printed or otherwise coated with signifiers. The rear surface of the translucent panel/card is likewise coated with peel-off or scratch-off regions with the following modification: Before coating or otherwise covering the rear surface, the clear card is also printed or otherwise imbued with signifiers, images, or portions thereof.

In one embodiment, selected areas of the transparent/translucent card are coated with obscuring regions of material of the same color or appearance (including random-like fields of confusing colors, shapes, or the like). In one embodiment, the fields are applied to the rear surface of the peel-off or scratch-off material affixed to the rear surface of the translucent layer.

In one embodiment, a desired result (e.g., a winning number or image, a desired phone-number, date, prize, or other required information) is divided across the multiple planes of a card. This division is likely done in X by Y regions which correspond to the regions defined by the layered reveal regions of the card. In one embodiment, the complexity of the encrypting of this data is further complicated through the use of operations by the information consumer that require the repositioning of the removable regions of either of the card's surfaces. This operation might include the removal of front or rear sections and their replacement onto the same, or opposing card-surfaces through the use of reusable adhesive or other methods. In other embodiments, further complication is added by addition or subtraction by the user of obscuring layers.

The signifiers in the information enable the information consumer to engage in the removal, application, and/or repositioning of the X by Y elements on either or both sides of the card. When this process is completed, the desired information, image, number, or signifier is revealed.

In one embodiment, the card has multiple layers. In another embodiment, there are multiple (clear) cards that are obtained from multiple sources. Operation of each card depends upon the source, the date of review, or other operator. After performing a series of signifier driven operation on the cards, the cards are stacked upon one another. In another embodiment, a fan-fold configuration is created which reveals a winning image or sequence only after the folding-together of multiple layers of such a card.

In another embodiment, a card is also modified by placement of a cut-out mask over or under the cards described above in order to modify, attenuate, or complete the image or sign appearing on the surfaces of the card. In one embodiment, scratch-off, tear-off, or peel-off layers are translucent and in this way make use of novel superimposition effects. In one embodiment, characters that appear to be present when viewing through the entirely translucent, tinted or transparent stack are made to disappear when appropriate layers are removed under instruction. Transparent layers tinted with the same color as the signifying markings below the tinted layer make layers below disappear, and complementary colors create the inverse effect.

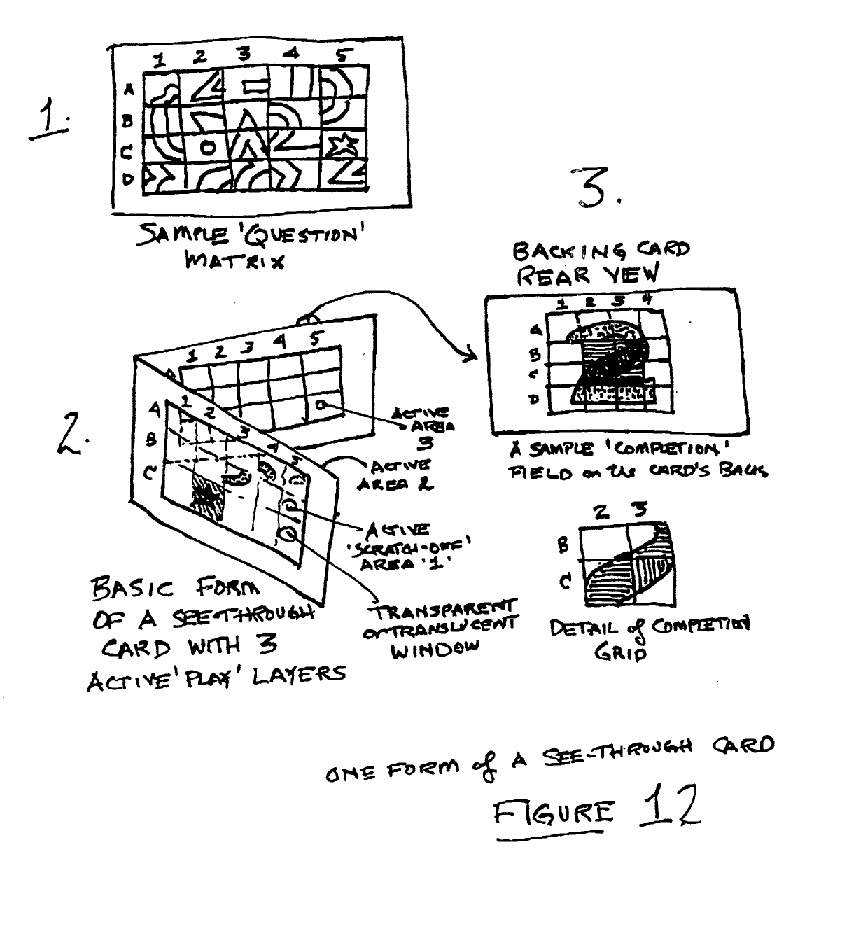

FIG. 12 illustrates portions of a recording card in accordance with one embodiment of the present invention. The recording card decodes a five-question series of signifiers with three possible responses per signifier A, B, or C. The card is made of a semi-rigid printable translucent sheeting. The area surrounding the window is opaquely printed with the framing surround bearing appropriate designations and/or instructions. The card depicted is scored, perforated or folded as shown. In another embodiment, the optional rear card is an entirely separate element.

Section 1 of the FIG. 12 shows the kind of overprinting that appears before removing regions of the card. Active Area 2 resides on the rear surface of the front piece of the card and contains a similar, aligned grid to the ones depicted. Section 2 shows the kind of printing or tinting or embedding that might occur in the transparent/translucent layer of the card. Also visible is the similar grid of the optional rear layer, Active Area 3.

Section 3 of the FIG. 12 shows an optional “completion” field which resides on the rear surface of the opaque rear card. This region is used to place random-looking responses to a number of acts of removing a peel-off element from some other area of the card. In one embodiment, this seemingly unrelated act to the creation of the composite being formed by the coincidence of layers seen through the front of the card adds critical missing information or additional “winning” opportunities to those appearing on the front surface of the card. In one embodiment, this is done by the surprising completion of a recognizable feature such as an image or alphanumeric character. Such a completion might be self-contained in the peeled-off elements, or they might simply complete a pattern by being placed within the context of a larger image or pattern.

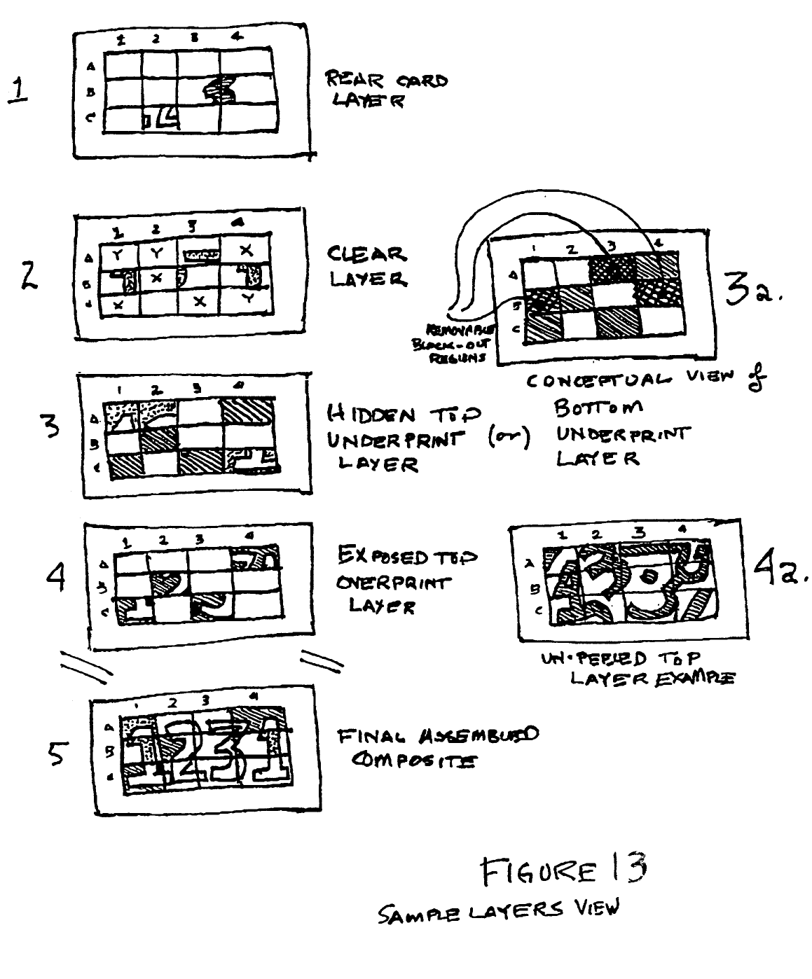

FIG. 13 illustrates a distribution of meaningful material over the multitude of surfaces of a recording card. Only the meaningful elements of such a distributed image or character (in this case, the ‘winning’ sequence 1-2-3-1) are shown. Layer 1 shows the front surface of the rear card. In actual use the empty fields are filled with visually confusing materials such as that depicted in 4a.

Layer 2 shows the contents of the clear layer. Empty fields marked with an ‘x’ are fields which have remained obscured, in this iteration, by the upper removable layer of the card. Empty fields are with a ‘y’ are those that are printed with material on the front or rear surface of the clear-layer. If printed on the front surface, then intentionally obscuring removable unprinting (the ‘black-out regions’), such as is described above, can be placed on the rear surfaces of the clear layer of the card. (One use of this is shown in section 3a.)

Layer 3 shows the areas printed on the front surface of the clear material of the card.

Layer 4 shows the material printed on the front surface of the removable front surface of the card. Part 5 of FIG. 13 shows the sample completed image formed by the layers when the card is viewed from the front with the rear card folded into position. Varying shades of tint are shown only to display the levels clearly. In actual practice the final composition would probably be rendered in homogeneous colors, textures, and densities.

In different embodiments, the central or transparent/translucent and perhaps tinted layer of a card employs lenticular technology, (reflective) holography, or other dynamic imaging or depth-imaging methodologies to embody a plurality of images, signifiers or their component parts, in order to create any of the sequential or three-dimensional effects possible with lenticular systems and the like. In another embodiment, a peel-off layer of transparent/translucent material with the complementary geometry to the lenticular screen and possessing the same or nearly the same index of refraction is placed against the lenticular prism or other optical layer, until the time of deployment. Thus, a motional, sequential, informational, or depth effect is created.

Regionally Specific Verification

In another embodiment, cards sent though e-mail, US mail, or received through local papers or magazines allow the encoding of various, unique, or differentiated “winning” response strings to be derived from the same signifier strings that appear sequentially in provided information. In another embodiment, multiple or variant signifiers placed in the information, or varied streams of signifiers such as might be created by a varying sequence of ad-insertions in, say, different geographic or demographic regions or groups, are employed to vary the actual response across the response grid or a card.

In one embodiment, certain combinations are disallowed to detect frivolous, intentional, or accidental misuse of the response system. In another embodiment, the card employed to respond to the presented signifier string is encoded with local phone numbers or variant toll-free numbers or other similar strategies. The toll-free number dialed, combined (or not) with a actual response string yields radically different results, like rewards or information.

Recording Cards as Part of Product

In one embodiment, recording cards are manufactured as an integral part of a product. In one embodiment, a see-through card is manufactured using the cover of a product as the medium. In another embodiment, the alignment of the DVD or CD disc is used to produce the second layer or x-layer of an assemblage such as is described above.

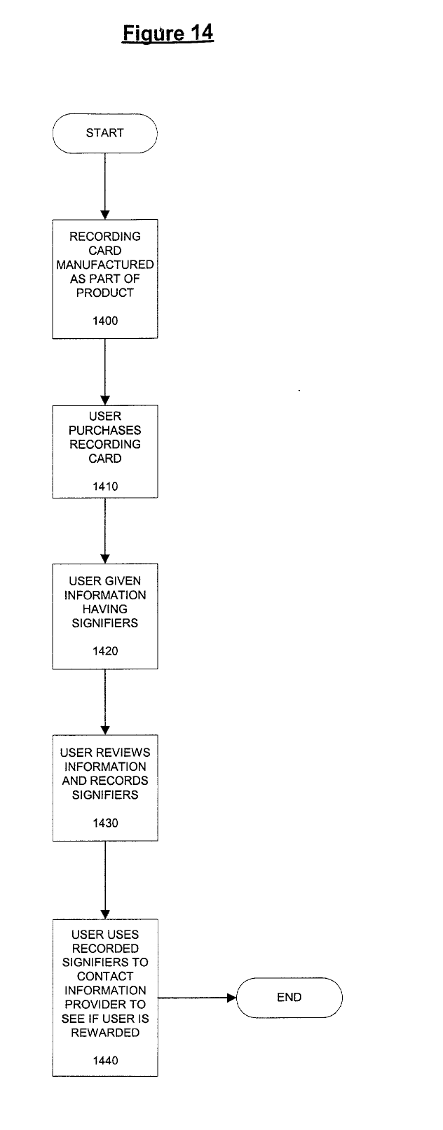

FIG. 14 illustrates the process of review verification in accordance with one embodiment of the present invention. At step 1400, a recording card is manufactured as an integral part of a product. At step 1410, a user purchases the product. At step 1420, the user is provided with information containing signifiers. At step 1430, the user reviews the information and records the signifiers using the recording card portion of the product. At step 1440, the user uses the recorded signifiers to contact the information provider and determine whether the user is to be rewarded, thus, verifying the user reviewed and comprehended the information.

Interactive Information Verification

In one embodiment, courseware, such as textbooks and AV-materials, are provided with signifiers embedded in them. Suitable software or other data-management tools would be provided to the teacher or supervisor to allow the inclusion of the signifier-string results in the analysis of the relative success or failure of a student to study and assimilate the presented information as well as the ancillary information also marked with signifiers.

A suitable system is provided by which to assimilate the raw signifier consumption data into such fields as: hours spent reading, listening, viewing or interacting; sections, pages, modules, or minutes mindfully consumed; time of consumption; mean duration of mindful consumption per module or page; and time spent, or number of modules requiring, reviewing or revisiting materials

In another embodiment, the field data is conformed by suitable algorithms or logical procedures into derived data such as weighting factors. In one embodiment, the derived data is used to weight or allow/disallow other aspects of the learning/instructional process. In one embodiment, below a certain threshold of mindful-consumption (wherein the threshold factor is derived from one or both hours spent or pages read) the results of an examination reviewing comprehension of that same learning material is suitably modified.

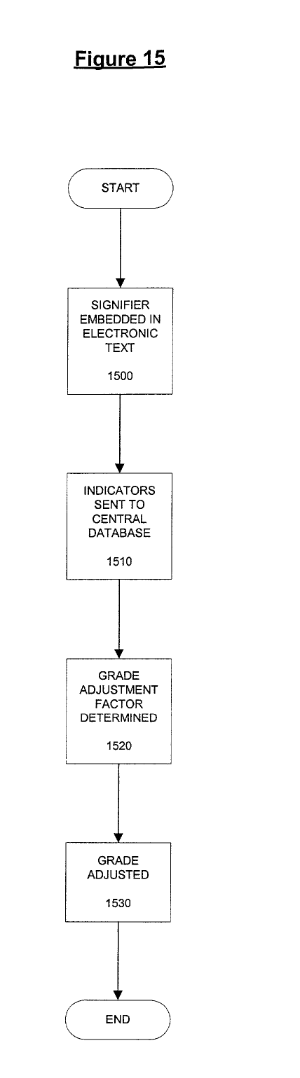

FIG. 15 illustrates the process of verifying student review of assigned text in accordance with one embodiment of the present invention. At step 1500, signifiers are embedded in electronically available assigned text. At step 1510, indicators are sent to a central database as a student reviews the assigned text. At step 1520, a grade adjustment factor is determined based on the indicators. At step 1530, the student's grade is adjusted.

The above embodiment allows a teacher to use less class time on determining through detailed knowledge testing to determine whether a student has read the assigned text. Reading the cliff notes would not enable the student to fool the teacher into thinking the student has reviewed the assigned text. Additionally, the possibility of a reduced grade for failure to review the assigned text and/or an increased grade for confirmed review of the assigned text is a strong incentive for students to review and comprehend the assigned text.

Information Consumer Presence Verification

In another embodiment, equipment is used to determine whether the information is physically present when information is provided. In one embodiment, a video camera is used to determine the location of the consumer. Video imaging techniques are used to determine whether the consumer is facing the information. In another embodiment, biometric or biological information is gathered to verify the physical presence of the information consumer.

In one embodiment, the consumer's finger print is repeatedly scanned during presentation of the information. In another embodiment, the consumer's heart rate, blood pressure or brain waves are monitored during presentation of the information. If the scanned information indicates the user is not present, review of information is not verified. If the scanned information indicates the user is present, review of information is verified.

In one embodiment, a computer system is provided for recording a sequence of signifiers that has been caused to be included within provided information, for receiving an indication of knowledge of the signifiers, for comparing the indication with a predetermined indication level, and for providing an output indicating whether or not the received indication demonstrates an entitlement to something of value. The output may be furnished as an audible or visible indication to the information consumer, as well as being stored in a memory location in a suitably designed database.

Embodiment of Computer Execution Environment (Hardware)

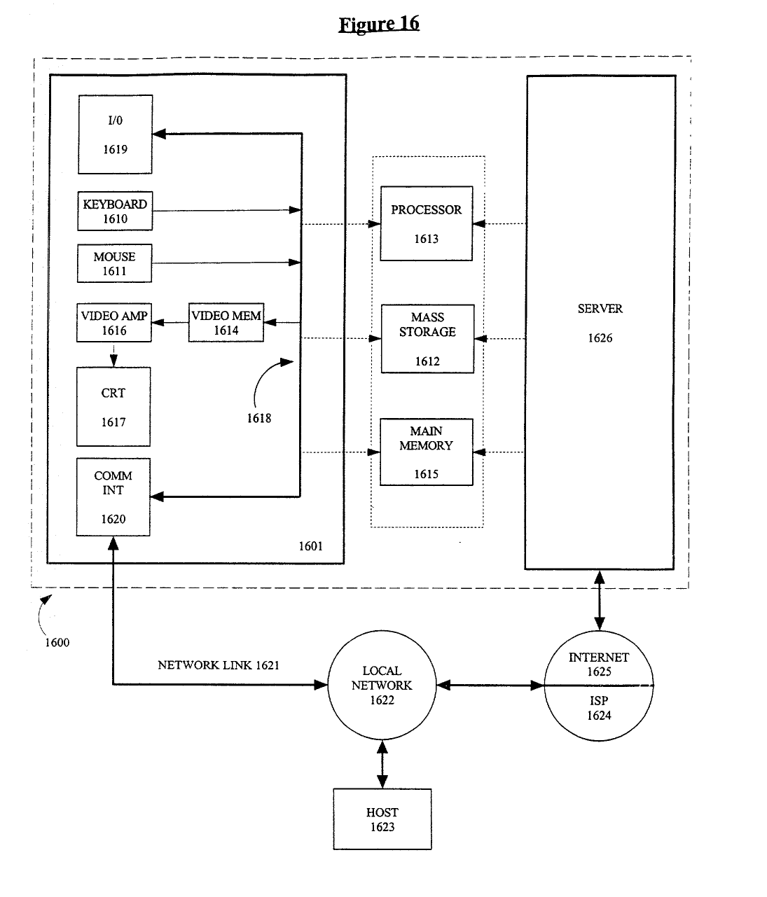

One or more embodiments of the present invention makes recording and/or viewing devices using a general purpose computing device as shown in FIG. 16. A keyboard 1610 and mouse 1611 are coupled to a system bus 1618. The keyboard and mouse are for introducing user input to the computer system and communicating that user input to central processing unit (CPU) 1613. Other suitable input devices may be used in addition to, or in place of, the mouse 1611 and keyboard 1610. I/O (input/output) unit 1619 coupled to bi-directional system bus 1618 represents such I/O elements as a printer, A/V (audio/video) I/O, etc.

Computer 1601 may include a communication interface 1620 coupled to bus 1618. Communication interface 1620 provides a two-way data communication coupling via a network link 1621 to a local network 1622. For example, if communication interface 1620 is an integrated services digital network (ISDN) card or a modem, communication interface 1620 provides a data communication connection to the corresponding type of telephone line, which comprises part of network link 1621. If communication interface 1620 is a local area network (LAN) card, communication interface 1620 provides a data communication connection via network link 1621 to a compatible LAN. Wireless links are also possible. In any such implementation, communication interface 1620 sends and receives electrical, electromagnetic or optical signals which carry digital data streams representing various types of information.

Network link 1621 typically provides data communication through one or more networks to other data devices. For example, network link 1621 may provide a connection through local network 1622 to local server computer 1623 or to data equipment operated by ISP 1624. ISP 1624 in turn provides data communication services through the world wide packet data communication network now commonly referred to as the “Internet” 1625. Local network 1622 and Internet 1625 both use electrical, electromagnetic or optical signals which carry digital data streams. The signals through the various networks and the signals on network link 1621 and through communication interface 1620, which carry the digital data to and from computer 1600, are exemplary forms of carrier waves transporting the information.

Processor 1613 may reside wholly on client computer 1601 or wholly on server 1626 or processor 1613 may have its computational power distributed between computer 1601 and server 1626. Server 1626 symbolically is represented in FIG. 16 as one unit, but server 1626 can also be distributed between multiple “tiers”. In one embodiment, server 1626 comprises a middle and back tier where application logic executes in the middle tier and persistent data is obtained in the back tier. In the case where processor 1613 resides wholly on server 1626, the results of the computations performed by processor 1613 are transmitted to computer 1601 via Internet 1625, Internet Service Provider (ISP) 1624, local network 1622 and communication interface 1620. In this way, computer 1601 is able to display the results of the computation to a user in the form of output.

Computer 1601 includes a video memory 1614, main memory 1615 and mass storage 1612, all coupled to bi-directional system bus 1618 along with keyboard 1610, mouse 1611 and processor 1613. As with processor 1613, in various computing environments, main memory 1615 and mass storage 1612, can reside wholly on server 1626 or computer 1601, or they may be distributed between the two. Examples of systems where processor 1613, main memory 1615, and mass storage 1612 are distributed between computer 1601 and server 1626 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 1612 may include both fixed and removable media, such as magnetic, optical or magnetic optical storage systems or any other available mass storage technology. Bus 1618 may contain, for example, thirty-two address lines for addressing video memory 1614 or main memory 1615. The system bus 1618 also includes, for example, a 32-bit data bus for transferring data between and among the components, such as processor 1613, main memory 1615, video memory 1614 and mass storage 1612. Alternatively, multiplex data/address lines may be used instead of separate data and address lines.

In one embodiment of the invention, the processor 1613 is a SPARC microprocessor from Sun Microsystems, Inc., a microprocessor manufactured by Motorola, such as the 680×0 processor, or a microprocessor manufactured by Intel, such as the 80×86 or Pentium processor. However, any other suitable microprocessor or microcomputer may be utilized. Main memory 1615 is comprised of dynamic random access memory (DRAM). Video memory 1614 is a dual-ported video random access memory. One port of the video memory 1614 is coupled to video amplifier 1616. The video amplifier 1616 is used to drive the cathode ray tube (CRT) raster monitor 1617. Video amplifier 1616 is well known in the art and may be implemented by any suitable apparatus. This circuitry converts pixel data stored in video memory 1614 to a raster signal suitable for use by monitor 1617. Monitor 1617 is a type of monitor suitable for displaying graphic images.

Computer 1601 can send messages and receive data, including program code, through the network(s), network link 1621, and communication interface 1620. In the Internet example, remote server computer 1626 might transmit a requested code for an application program through Internet 1625, ISP 1624, local network 1622 and communication interface 1620. The received code may be executed by processor 1613 as it is received, and/or stored in mass storage 1612, or other non-volatile storage for later execution. In this manner, computer 1600 may obtain application code in the form of a carrier wave. Alternatively, remote server computer 1626 may execute applications using processor 1613, and utilize mass storage 1612, and/or video memory 1615. The results of the execution at server 1626 are then transmitted through Internet 1625, ISP 1624, local network 1622 and communication interface 1620. In this example, computer 1601 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

One or more embodiments of the present invention have been described in connection with a device which records media or views media. It is understood by one skilled in the art that any media viewer or media recorder can be used with the present invention. Typical media viewers and/or media recorders include VCRs, digital video disk players, digital video disk recorders, set top boxes, interactive television sets and the like.

Thus, a method and apparatus for verifying review and comprehension of information is described in conjunction with one or more specific embodiments. The invention is defined by the following claims and their full scope and equivalents.

1. A method for verification of review of a provided information by an information consumer comprising:
inserting one or more signifiers into said provided information;
providing an incentive for said information consumer to review said provided information; and
delivering said incentive to said information consumer, if said information consumer indicates sufficient knowledge of said signifiers.

2. The method of claim 1 wherein said incentive is reduced cost to said information consumer for a product.

3. The method of claim 1 wherein said incentive is reduced cost to said information consumer for a service.

4. The method of claim 1 wherein said step of delivering comprises:
determining whether a number of signifiers to which said information consumer has indicated knowledge is higher than a threshold value.

5. The method of claim 1 wherein said step of delivering comprises:
deriving a number by applying a formula to said information consumer's indications of signifier knowledge; and
determining whether said number is higher than a threshold value.

6. The method of claim 1 wherein knowledge of a first signifier is indicated by placing a telephone call.

7. The method of claim 1 wherein knowledge of a first signifier is indicated by connection to a web site.

8. The method of claim 1 wherein knowledge of a first signifier is indicated by sending an electronic mail message.

9. The method of claim 1 wherein knowledge of a first signifier is indicated by sending a postal mailing.

10. The method of claim 1 wherein knowledge of a first signifier is indicated by sending a facsimile.

11. The method of claim 1 wherein knowledge of a first signifier is indicated by transmitting a written response.

12. The method of claim 1 wherein said step of delivering comprises:
providing a conversion code; and
converting said signifiers into desired information using said conversion code.

13. The method of claim 12 wherein said desired information is contact information.

14. The method of claim 12 wherein said desired information is a lottery number.

15. The method of claim 12 wherein said desired information is a number that grants said information consumer access to said incentive.

16. The method of claim 12 wherein said conversion code is provided in the form of a game card.

17. The method of claim 16 wherein said desired information is directly revealed by said signifiers.

18. The method of claim 16 wherein said desired information is revealed by a scratch-off pattern indicated by said signifiers.

19. The method of claim 16 wherein said desired information is revealed by a peel-off pattern indicated by said signifiers.

20. The method of claim 16 wherein said desired information is revealed by an add-on pattern indicated by said signifiers.

21. The method of claim 1 wherein said provided information is divided into partitions.

22. The method of claim 1 wherein said incentive is the ability to use a product.

23. The method of claim 22 wherein said product is medication.

24. The method of claim 23 wherein said provided information is medical instructions.

25. The method of claim 1 wherein said provided information is instructional material for a product.

26. The method of claim 25 wherein said incentive is improved customer support for said product.

27. The method of claim 1 wherein said incentive comprises:
a second provided information wherein said second provided information contains one or more second signifiers.

28. The method of claim 1 further comprising:
providing said provided information at an event.

29. The method of claim 28 wherein said provided information is one or more advertisements on the wall of a structure.

30. The method of claim 28 wherein said provided information is one or more advertisements on the field of a ball park.

31. The method of claim 28 wherein said provided information is one or more images added to a video image of said event.

32. The method of claim 1 further comprising:
partitioning said provided information into a number of partitions; and
associating each of said partitions with a unitary product wherein all of said unitary products with which said partitions are associate are sold together as one product.

33. The method of claim 1 further comprising:
providing a recording card.

34. The method of claim 33 wherein said recording card has more than one layer.

35. The method of claim 34 wherein each layer contains printed information.

36. The method of claim 35 wherein a first layer has underprinting.

37. The method of claim 36 wherein said step of delivering comprises:
manipulating said layers of said recording card.

38. The method of claim 37 wherein said step of manipulating comprises:
removing printing.

39. The method of claim 37 wherein said step of manipulating comprises:
moving printing.

40. The method of claim 37 wherein said step of manipulating comprises:
removing underprinting.

41. The method of claim 37 wherein said step of manipulating comprises:
moving underprinting.

42. The method of claim 37 wherein said step of manipulating comprises:
removing a first layer.

43. The method of claim 37 wherein said step of manipulating comprises:
moving a first layer

44. The method of claim 33 wherein said recording card is integrated into a product.

45. The method of claim 44 wherein said recording card is part of the case of said product.

46. The method of claim 1 wherein said signifiers encode regional information.

47. The method of claim 1 wherein said provided information is an assigned text in electronic form.

48. The method of claim 47 wherein said step of delivering comprises:
electronically detecting said signifiers as said information consumer reviews said text;
transmitting said detected signifiers to a sufficiency determiner; and
determining whether said detected signifiers are sufficient to earn said information consumer said incentive.

49. The method of claim 1 further comprising:
detecting a physical presence of said information consumer.

50. A review verification system comprising:
an insertion unit configured to insert one or more signifiers into a provided information;
an incentive system configured to provide an incentive for a information consumer to review said provided information; and
a delivery system configured to deliver said incentive to said information consumer, if said information consumer indicates sufficient knowledge of said signifiers.

51. The review verification system of claim 50 wherein said incentive is reduced cost to said information consumer for a product.

52. The review verification system of claim 50 wherein said incentive is reduced cost to said information consumer for a service.

53. The review verification system of claim 50 wherein said delivery system comprises:
a determiner configured to determine whether a number of signifiers to which said information consumer has indicated knowledge is higher than a threshold value.

54. The review verification system of claim 50 wherein said delivery system comprises:
a derivation unit configured to derive a number by applying a formula to said information consumer's indications of signifier knowledge; and
a determiner configured to determine whether said number is higher than a threshold value.

55. The review verification system of claim 50 wherein knowledge of a first signifier is indicated by placing a telephone call.

56. The review verification system of claim 50 wherein knowledge of a first signifier is indicated by connection to a web site.

57. The review verification system of claim 50 wherein knowledge of a first signifier is indicated by sending an electronic mail message.

58. The review verification system of claim 50 wherein knowledge of a first signifier is indicated by sending a postal mailing.

59. The review verification system of claim 50 wherein knowledge of a first signifier is indicated by sending a facsimile.

60. The review verification system of claim 50 wherein knowledge of a first signifier is indicated by transmitting a written response.

61. The review verification system of claim 50 wherein said delivery system comprises:
a mechanism configured to provide a conversion code; and
a converter configured to convert said signifiers into desired information using said conversion code.

62. The review verification system of claim 61 wherein said desired information is contact information.

63. The review verification system of claim 61 wherein said desired information is a lottery number.

64. The review verification system of claim 61 wherein said desired information is a number that grants said information consumer access to said incentive.

65. The review verification system of claim 61 wherein said conversion code is provided in the form of a game card.

66. The review verification system of claim 65 wherein said desired information is directly revealed by said signifiers.

67. The review verification system of claim 65 wherein said desired information is revealed by a scratch-off pattern indicated by said signifiers.

68. The review verification system of claim 65 wherein said desired information is revealed by a peel-off pattern indicated by said signifiers.

69. The review verification system of claim 65 wherein said desired information is revealed by an add-on pattern indicated by said signifiers.

70. The review verification system of claim 50 wherein said provided information is divided into partitions.

71. The review verification system of claim 50 wherein said incentive is the ability to use a product.

72. The review verification system of claim 71 wherein said product is medication.

73. The review verification system of claim 72 wherein said provided information is medical instructions.

74. The review verification system of claim 50 wherein said provided information is instructional material for a product.

75. The review verification system of claim 74 wherein said incentive is improved customer support for said product.

76. The review verification system of claim 50 wherein said incentive comprises:
a second provided information wherein said second provided information contains one or more second signifiers.

77. The review verification system of claim 50 further comprising:
providing said provided information at an event.

78. The review verification system of claim 77 wherein said provided information is one or more advertisements on the wall of a structure.

79. The review verification system of claim 77 wherein said provided information is one or more advertisements on the field of a ball park.

80. The review verification system of claim 77 wherein said provided information is one or more images added to a video image of said event.

81. The review verification system of claim 50 further comprising:
a partitioner configured to partition said provided information into a number of partitions; and
an association unit configured to associate each of said partitions with a unitary product wherein all of said unitary products with which said partitions are associate are sold together as one product.

82. The review verification system of claim 50 further comprising:
a mechanism configured to provide a recording card.

83. The review verification system of claim 82 wherein said recording card has more than one layer.

84. The review verification system of claim 83 wherein each layer contains printed information.

85. The review verification system of claim 84 wherein a first layer has underprinting.

86. The review verification system of claim 85 wherein said delivery system comprises:
a manipulation unit configured to manipulate said layers of said recording card.

87. The review verification system of claim 86 wherein said manipulation unit comprises:
a print removing unit configured to remove printing.

88. The review verification system of claim 86 wherein said manipulation unit comprises:
a print moving unit configured to move printing.

89. The review verification system of claim 86 wherein said manipulation unit comprises:
an underprinting removing unit configured to remove underprinting.

90. The review verification system of claim 86 wherein said manipulation unit comprises:
an underprinting moving unit configured to move underprinting.

91. The review verification system of claim 86 wherein said manipulation unit comprises:
a layer removing unit configured to remove a first layer.

92. The review verification system of claim 86 wherein said manipulation unit comprises:
a layer moving unit configured to move a first layer

93. The review verification system of claim 82 wherein said recording card is integrated into a product.

94. The review verification system of claim 93 wherein said recording card is part of the case of said product.

95. The review verification system of claim 50 wherein said signifiers encode regional information.

96. The review verification system of claim 50 wherein said provided information is an assigned text in electronic form.

97. The review verification system of claim 96 wherein said delivery system comprises:
a detector configured to electronically detect said signifiers as said information consumer reviews said text;
a transmitter configured to transmit said detected signifiers to a sufficiency determiner; and
a determiner configured to determine whether said detected signifiers are sufficient to earn said information consumer said incentive.

98. The review verification system of claim 50 further comprising:
a detector configured to detect a physical presence of said information consumer.

99. A computer program product comprising:
a computer usable medium having computer readable program code embodied therein configured to verify review of a provided information by an information consumer, said computer program product comprising:
computer readable code configured to cause a computer to insert one or more signifiers into a provided information;
computer readable code configured to cause a computer to provide an incentive for a information consumer to review said provided information; and
computer readable code configured to cause a computer to deliver said incentive to said information consumer, if said information consumer indicates sufficient knowledge of said signifiers.

100. The computer program product of claim 99 wherein said incentive is reduced cost to said information consumer for a product.

101. The computer program product of claim 99 wherein said incentive is reduced cost to said information consumer for a service.

102. The computer program product of claim 99 wherein said computer readable code configured to cause a computer to deliver comprises:
computer readable code configured to cause a computer to determine whether a number of signifiers to which said information consumer has indicated knowledge is higher than a threshold value.

103. The computer program product of claim 99 wherein said computer readable code configured to cause a computer to deliver comprises:
computer readable code configured to cause a computer to derive a number by applying a formula to said information consumer's indications of signifier knowledge; and
computer readable code configured to cause a computer to determine whether said number is higher than a threshold value.

104. The computer program product of claim 99 wherein knowledge of a first signifier is indicated by placing a telephone call.

105. The computer program product of claim 99 wherein knowledge of a first signifier is indicated by connection to a web site.

106. The computer program product of claim 99 wherein knowledge of a first signifier is indicated by sending an electronic mail message.

107. The computer program product of claim 99 wherein knowledge of a first signifier is indicated by sending a postal mailing.

108. The computer program product of claim 99 wherein knowledge of a first signifier is indicated by sending a facsimile.

109. The computer program product of claim 99 wherein knowledge of a first signifier is indicated by transmitting a written response.

110. The computer program product of claim 99 wherein said computer readable code configured to cause a computer to deliver comprises:
computer readable code configured to cause a computer to provide a conversion code; and
computer readable code configured to cause a computer to convert said signifiers into desired information using said conversion code.

111. The computer program product of claim 110 wherein said desired information is contact information.

112. The computer program product of claim 110 wherein said desired information is a lottery number.

113. The computer program product of claim 110 wherein said desired information is a number that grants said information consumer access to said incentive.

114. The computer program product of claim 110 wherein said conversion code is provided in the form of a game card.

115. The computer program product of claim 114 wherein said desired information is directly revealed by said signifiers.

116. The computer program product of claim 114 wherein said desired information is revealed by a scratch-off pattern indicated by said signifiers.

117. The computer program product of claim 114 wherein said desired information is revealed by a peel-off pattern indicated by said signifiers.

118. The computer program product of claim 114 wherein said desired information is revealed by an add-on pattern indicated by said signifiers.

119. The computer program product of claim 99 wherein said provided information is divided into partitions.

120. The computer program product of claim 99 wherein said incentive is the ability to use a product.

121. The computer program product of claim 120 wherein said product is medication.

122. The computer program product of claim 121 wherein said provided information is medical instructions.

123. The computer program product of claim 99 wherein said provided information is instructional material for a product.

124. The computer program product of claim 123 wherein said incentive is improved customer support for said product.

125. The computer program product of claim 99 wherein said incentive comprises:
a second provided information wherein said second provided information contains one or more second signifiers.

126. The computer program product of claim 99 further comprising:
providing said provided information at an event.

127. The computer program product of claim 126 wherein said provided information is one or more advertisements on the wall of a structure.

128. The computer program product of claim 126 wherein said provided information is one or more advertisements on the field of a ball park.

129. The computer program product of claim 126 wherein said provided information is one or more images added to a video image of said event.

130. The computer program product of claim 99 further comprising:
computer readable code configured to cause a computer to partition said provided information into a number of partitions; and
computer readable code configured to cause a computer to associate each of said partitions with a unitary product wherein all of said unitary products with which said partitions are associate are sold together as one product.

131. The computer program product of claim 99 further comprising:
computer readable code configured to cause a computer to provide a recording card.

132. The computer program product of claim 131 wherein said recording card has more than one layer.

133. The computer program product of claim 132 wherein each layer contains printed information.

134. The computer program product of claim 133 wherein a first layer has underprinting.

135. The computer program product of claim 134 wherein said computer readable code configured to cause a computer to deliver comprises:
computer readable code configured to cause a computer to manipulate said layers of said recording card.

136. The computer program product of claim 135 wherein said computer readable code configured to cause a computer to manipulate comprises:
computer readable code configured to cause a computer to remove printing.

137. The computer program product of claim 135 wherein said computer readable code configured to cause a computer to manipulate comprises:
computer readable code configured to cause a computer to move printing.

138. The computer program product of claim 135 wherein said computer readable code configured to cause a computer to manipulate comprises:
computer readable code configured to cause a computer to remove underprinting.

139. The computer program product of claim 135 wherein said computer readable code configured to cause a computer to manipulate comprises:
computer readable code configured to cause a computer to move underprinting.

140. The computer program product of claim 135 wherein said computer readable code configured to cause a computer to manipulate comprises:
computer readable code configured to cause a computer to remove a first layer.

141. The computer program product of claim 135 wherein said computer readable code configured to cause a computer to manipulate comprises:
computer readable code configured to cause a computer to move a first layer

142. The computer program product of claim 131 wherein said recording card is integrated into a product.

143. The computer program product of claim 142 wherein said recording card is part of the case of said product.

144. The computer program product of claim 99 wherein said signifiers encode regional information.

145. The computer program product of claim 99 wherein said provided information is an assigned text in electronic form.

146. The computer program product of claim 145 wherein said computer readable code configured to cause a computer to deliver comprises:
computer readable code configured to cause a computer to electronically detect said signifiers as said information consumer reviews said text;
computer readable code configured to cause a computer to transmit said detected signifiers to a sufficiency determiner; and
computer readable code configured to cause a computer to determine whether said detected signifiers are sufficient to earn said information consumer said incentive.

147. The computer program product of claim 99 further comprising:
computer readable code configured to cause a computer to detect a physical presence of said information consumer.
